(19) United States
(12) Patent Application Publication
(10) Pub. No.: US 2021/0100077 A1
(43) Pub. Date: Apr. 1, 2021

(54) COMMERCIAL MICROWAVE OVEN

(71) Applicant: PRESIDENT CHAIN STORE CORP., Taipei City (TW)

(72) Inventors: Ying-Szu Hung, Taipei City (TW); Li-Ping Yang, Taipei City (TW)

(21) Appl. No.: 16/943,382

(22) Filed: Jul. 30, 2020

(30) Foreign Application Priority Data
Sep. 26, 2019 (TW) 108212800

(51) Int. Cl. H05B 6/64; H05B 6/68

(52) U.S. Cl. CPC H05B 6/6447; H05B 6/6414; H05B 6/80; H05B 6/68; H05B 6/6435

(57) ABSTRACT

A commercial microwave oven includes a main body, a door panel, a door closing sensing device, a scanning device, and a processor. The main body includes an opening. The door panel is pivotally disposed on the main body and capable of selectively moving away from or covering the opening. The door closing sensing device is disposed between the door panel and the main body, and transmits a door closing signal when the door panel covers the opening. The scanning device obtains a heating power parameter and a heating time parameter through scanning. The processor is electrically connected to the door closing sensing device and the scanning device, and controls, upon receipt of the door closing signal, the main body to operate according to the heating power parameter and the heating time parameter. The microwave oven can be operated rapidly and used flexibly, thereby saving time by simplifying an operation procedure.

### CROSS-REFERENCE TO RELATED APPLICATION

This non-provisional application claims priority under 35 U.S.C. § 119(a) to Patent Application No. 108212800 filed in Taiwan, R.O.C. on Sep. 26, 2019, the entire contents of which are hereby incorporated by reference.

### BACKGROUND

### Technical Field

The present invention relates to a microwave oven, and in particular, to a commercial microwave for automatic scanning and microwave heating.

### Related Art

Generally, a shopping mall provides a variety of microwave-heatable foods or beverages. In order to allow consumers to conveniently heat such products to eat after purchase in the shopping mall, one or more commercial microwave ovens are provided in the shopping mall for use by store staffs or consumers. In order to facilitate the store staffs or consumers to operate the microwave oven intuitively, an existing commercial microwave oven is provided with a fixed number of buttons. These buttons are preset with specific microwave heating power and heating time, and therefore the store staffs or consumers can simply press a corresponding button for microwave heating of a product, without spending time adjusting and setting the heating power and the heating time of the microwave oven.

However, when items of microwave products being sold continue to be increased, the specific buttons that have been set are not enough for use, or when the microwave power and time need to be fine-tuned for personal needs of the consumers or for different microwave products as required, the corresponding button often cannot be found for use. In this case, the store staffs or consumers need to turn on the microwave again and press a closest button to temporarily respond. As a result, the existing commercial microwave oven is not flexible and cumbersome in process, and thus does not meet practical needs.

### SUMMARY

The present invention provides a commercial microwave oven, including a main body, a door panel, a door closing sensing device, a scanning device, and a processor. The main body includes an opening and an accommodation space; the door panel is pivotally disposed on the main body and capable of selectively moving away from or covering the opening; the door closing sensing device is disposed between the door panel and the main body, and transmits a door closing signal when the door panel covers the opening; the scanning device is disposed in an inner wall of the accommodation space, and obtains a heating power parameter and a heating time parameter through scanning; and the processor is disposed on the main body and electrically connected to the door closing sensing device and the scanning device, and controls, upon receipt of the door closing signal, the main body to operate according to the heating power parameter and the heating time parameter. Therefore, the commercial microwave oven according to the present invention can perform microwave heating as soon as the door panel is closed, and is rapid and simple in operation.

In some embodiments, the scanning device may be a bar code scanning device, where the heating power parameter and the heating time parameter may be recorded in a bar code label, and the bar code scanning device may obtain the heating power parameter and the heating time parameter by scanning and reading the bar code label.

In some embodiments, the scanning device may be an optical camera device, where the heating power parameter and the heating time parameter may be recorded in a graphic label, and the optical camera device may obtain the heating power parameter and the heating time parameter by scanning and recognizing the graphic label.

In some embodiments, the scanning device may include a scanning window disposed in an inner top wall of the accommodation space adjacent to the opening. Therefore, the scanning device may scan, through the scanning window, an external bar code label, a graphic label, an electronic label, or other equivalent elements recorded with the heating power parameter and the heating time parameter.

In some embodiments, the main body may further include a control panel, where the control panel is electrically connected to the processor, and may modify or adjust the heating power parameter or the heating time parameter. Therefore, microwave power and time of the commercial microwave oven according to the present invention can be simply fine-tuned for personal needs of consumers or for different microwave products. The microwave oven according to the present invention is more efficient for flexible use.

In some embodiments, the main body may further include a memory, where the memory is electrically connected to the processor, and may store the heating power parameter or the heating time parameter or store the heating power parameter or the heating time parameter adjusted through the control panel.

In some embodiments, the main body may further include a display screen, where the display screen is electrically connected to the processor, and may display the heating power parameter or the heating time parameter or a combination thereof.

In some embodiments, the memory may store the heating power parameter or the heating time parameter or the combination thereof displayed on the display screen.

In some embodiments, the door closing sensing device may be a micro switch, a limit switch, or a proximity switch.

In summary, the commercial microwave oven provided in the present invention has the following advantages: The commercial microwave oven can be operated rapidly and used flexibly, and is not limited by heating time and heating power to which a button corresponds, a microwave procedure can be performed as soon as the door panel is closed, a cumbersome use process is simplified to save time, and parameters can be fine-tuned or modified through a manual control panel, thereby meeting practical needs.

Detailed features and advantages of the present invention are described in detail in the following implementations, and the content of the implementations is sufficient for a person skilled in the art to understand and implement the technical content of the present invention. A person skilled in the art can easily understand the objectives and advantages related to the present invention according to the contents disclosed in this specification, the claims and the drawings.

### BRIEF DESCRIPTION OF THE DRAWINGS

FIG. 1 is a schematic diagram of a use status of a microwave oven according to a first embodiment of the present invention.

FIG. 2 is a schematic block diagram of an electrical connection between electronic elements of the microwave oven in the first embodiment of the present invention.

FIG. 3 is a schematic diagram of a use status of a microwave oven according to a second embodiment of the present invention.

### DETAILED DESCRIPTION

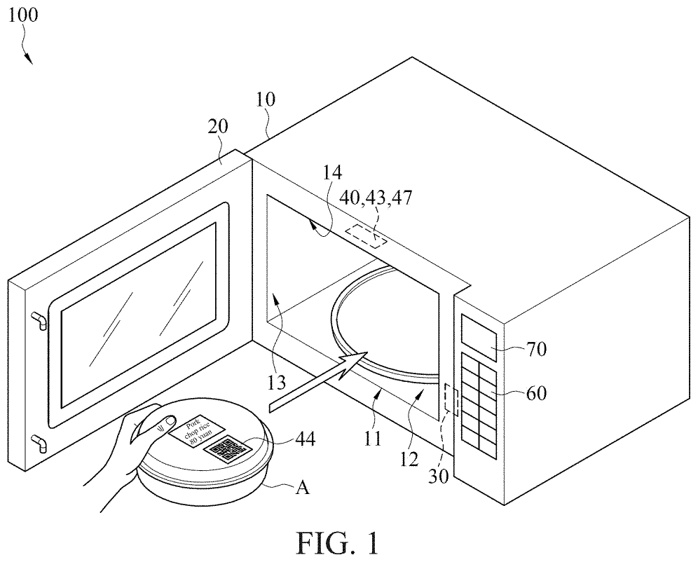

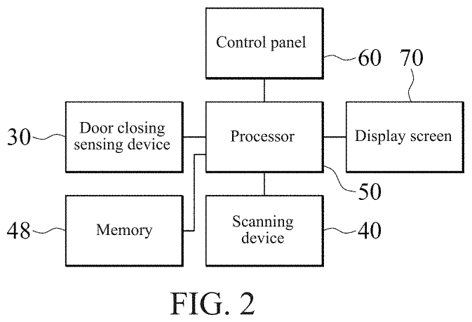

FIG. 1 and FIG. 2 illustrate a microwave oven according to a first embodiment of the present invention. FIG. 1 is a schematic diagram of a use status. FIG. 2 is a schematic block diagram of an electrical connection between electronic elements. Referring to FIG. 1, a microwave oven 100 in this embodiment includes a main body 10, a door panel 20, a door closing sensing device 30, a scanning device 40, and a processor 50.

Referring to FIG. 1, the commercial microwave oven in this embodiment is used in a convenience store. The main body 10 of the microwave oven 100 is provided with an opening 11 at one side and has an accommodation space 12 formed therein. The door panel 20 is pivotally disposed on the main body 10 and capable of selectively moving away from or covering the opening 11. The door closing sensing device 30 in this embodiment is disposed between the door panel 20 and the main body 10. The door closing sensing device 30 may transmit a door closing signal when the door panel 20 covers the opening 11. The scanning device 40 is disposed in an inner wall 13 on a top surface of the accommodation space 12, and can scan a product at the opening 11 to obtain a heating power parameter and a heating time parameter. In particular, the scanning device 40 in this embodiment has a scanning window 47 disposed in an inner top wall 14 in the accommodation space 12. As shown in FIG. 1, the scanning window 47 in this embodiment is adjacent to the opening 11, and thus can regularly scan an object passing through the opening 11. The scanning device 40 in this embodiment is a bar code scanning device 43, which can scan a bar code label 44 on a product A, to read the heating power parameter and the heating time parameter recorded in the bar code label 44. In this way, microwave parameter information can be obtained.

Referring to FIG. 1 and FIG. 2, the processor 50 disposed in the main body 10 is electrically connected to the door closing sensing device 30 and the scanning device 40. Therefore, upon receipt of the door closing signal, the processor 50 can immediately control the main body 10 to operate according to the heating power parameter and the heating time parameter, to perform a heating procedure on the product A. Therefore, the commercial microwave oven in the embodiment can perform microwave heating as soon as the door panel 20 is closed, and can be operated rapidly, thereby simplifying a cumbersome use process to save time.

Referring to FIG. 1, in the first embodiment, a control panel 60 is a button control panel, but is not limited thereto. In other embodiments, the control panel 60 may be a touch panel, for example, an on-cell or embedded touch panel.

Referring to FIG. 1 and FIG. 2, the control panel 60 is further provided in the main body 10 in the first embodiment, and is electrically connected to the processor 50. The control panel 60 may be used by a user to modify or adjust the heating power parameter or the heating time parameter, and thus can be flexibly used. The control panel is not limited by heating time and heating power to which a customary button corresponds.

Referring to FIG. 1 and FIG. 2, a memory 48 is further provided in the main body 10 in the first embodiment, and is electrically connected to the processor 50. The memory 48 is configured to store the heating power parameter or the heating time parameter or a combination thereof adjusted through the control panel 60.

The scanning device 40 may scan, through the scanning window 47, the external bar code label 44, a graphic label 46, an electronic label, or other equivalent elements recorded with the heating power parameter and the heating time parameter.

Referring to FIG. 1 and FIG. 2, in the first embodiment, the main body 10 further includes a display screen 70 electrically connected to the processor 50. The display screen 70 may display the heating power parameter or the heating time parameter for viewing by the user. If the user needs to adjust a microwave procedure provided by the original bar code label 44, the graphic label 46, or the electronic label as required, the user may modify the heating power parameter or the heating time parameter or a combination thereof through the control panel 60. Therefore, microwave power and time can be simply fine-tuned for personal needs of consumers or for different microwave products. The microwave oven in this embodiment is more efficient for flexible use.

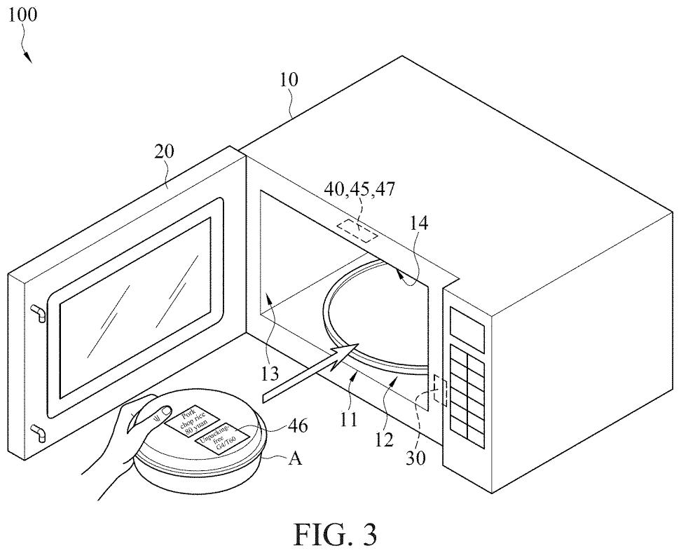

FIG. 3 is a schematic diagram of a use status of a microwave oven according to a second embodiment of the present invention. In this embodiment, elements are substantially the same as those in the first embodiment. A scanning device 40 in this embodiment is an optical camera device 45, which can scan a graphic label 46 on a product A, to read a heating power parameter and a heating time parameter recorded in the graphic label 46. In this way, microwave parameter information can be obtained.

In another embodiment of the present invention, the scanning device 40 is a bar code scanning device 43, which can scan a bar code label 44 on a product A. After receiving bar code information transmitted by the bar code scanning device 43, a processor 50 interprets the bar code information to obtain the heating power parameter and the heating time parameter for the product A.

In other embodiments, a door closing sensing device 30 may be a micro switch, a limit switch, or a proximity switch, all of which can realize a rapid operation, simplify a cumbersome use process, and save time.

For example, foods taken from a freezer need to be de-iced with low heating power, then cooked thoroughly with high heating power, and given a flavour with intermediate heating power. Heating power and time of these three different procedures may be read by the scanning device 40 on the microwave oven 100 by scanning the bar code label 44, the graphic label 46, the electronic label, or the like, which is produced by a generator and adhered to to-be-heated foods. The microwave heating procedure can be completed in one turn-on operation, thereby simplifying the operation procedure. The bar code label 44, the graphic label 46, the electronic label, or the like is produced by a bar code generator, and can be adjusted according to foods or beverages that require microwave heating. There are unlimited groups of microwave mode combinations, which do not require the user to manually set one by one, thereby simplifying a personnel operation procedure and saving time.

In summary, the commercial microwave oven provided in the present invention has the following advantages: The commercial microwave oven can be operated rapidly and used flexibly, and is not limited by heating time and heating power to which a button corresponds, a microwave procedure can be performed as soon as the door panel is closed, a cumbersome use process is simplified to save time, and parameters can be fine-tuned or modified through a manual control panel, thereby meeting practical needs.

What is claimed is:

1. A commercial microwave oven, comprising:
a main body comprising an opening and an accommodation space;
a door panel pivotally disposed on the main body and capable of selectively moving away from or covering the opening;
a door closing sensing device disposed between the door panel and the main body and transmitting a door closing signal when the door panel covers the opening;
a scanning device disposed in an inner wall of the accommodation space and obtaining a heating power parameter and a heating time parameter through scanning; and
a processor disposed on the main body, electrically connected to the door closing sensing device and the scanning device, and controlling, upon receipt of the door closing signal, the main body to operate according to the heating power parameter and the heating time parameter.

2. The commercial microwave oven according to claim 1, wherein the scanning device is a bar code scanning device, the heating power parameter and the heating time parameter are recorded in a bar code label, and the bar code scanning device obtains the heating power parameter and the heating time parameter by scanning and reading the bar code label.

3. The commercial microwave oven according to claim 1, wherein the scanning device is an optical camera device, the heating power parameter and the heating time parameter are recorded in a graphic label, and the optical camera device obtains the heating power parameter and the heating time parameter by scanning and recognizing the graphic label.

4. The commercial microwave oven according to claim 1, wherein the scanning device comprises a scanning window disposed at an inner top wall of the accommodation space adjacent to the opening.

5. The commercial microwave oven according to claim 1, wherein the main body further comprises a control panel electrically connected to the processor and adjusting the heating power parameter and the heating time parameter.

6. The commercial microwave oven according to claim 5, wherein the main body further comprises a memory electrically connected to the processor and storing the heating power parameter or the heating time parameter adjusted through the control panel.

7. The commercial microwave oven according to claim 1, wherein the main body further comprises a memory electrically connected to the processor and storing the heating power parameter or the heating time parameter or a combination thereof.

8. The commercial microwave oven according to claim 1, wherein the main body further comprises a display screen electrically connected to the processor and displaying the heating power parameter or the heating time parameter or a combination thereof.

9. The commercial microwave oven according to claim 8, wherein the main body further comprises a memory storing the heating power parameter or the heating time parameter or the combination thereof displayed on the display screen.

10. The commercial microwave oven according to claim 1, wherein the door closing sensing device is a micro switch, a limit switch, or a proximity switch.
